(19) United States
(12) Patent Application Publication
(10) Pub. No.: US 2021/0017947 A1
(43) Pub. Date: Jan. 21, 2021

(54) METHOD FOR DESIGNING AND PRODUCING TURBINES HAVING BUCKETS WITH CALIBRATED JETS

(71) Applicant: Carpyz SAS, Paris (FR)

(72) Inventor: Pierre CARROUSET, Paris (FR)

(21) Appl. No.: 17/042,346

(22) PCT Filed: Mar. 22, 2019
(86) PCT No.: PCT/EP2019/057216

§ 371 Date: Sep. 28, 2020

(30) Foreign Application Priority Data
Mar. 28, 2018 (LU) LU100749

(51) Int. Cl. F03B 1/02; F03D 1/06; F03D 3/06; G06F 30/10

(52) U.S. Cl. CPC F03B 1/02; F03D 1/0683; F03D 3/062; G06F 2113/08; F05B 2220/30; F05B 2240/21; F05B 2240/241; G06F 30/10

(57) ABSTRACT

The invention relates to a method for designing and fabricating bucket turbines with calibrated jets characterised in that the skeletons of the turbines displayed on the screen allow them to be designed and then fabricated in any dimensions, any materials and any quantities, and they are built with blades designed according to the so-called five-parameter arithmetic principle, the skeleton of the turbine is displayed on the screen by means of “virtual neutral fibres” which are subsequently covered with a material, the turbines being contained, over the entire length thereof, in a circular envelope, which is in principle slightly rounded and has a diameter that varies over the length thereof according to the contents of the envelope, and the length of said single-component envelope is shown on a drawing and divided into four zones intersected by temporary virtual discs which each separate the zones according to the functions carried out in these areas, the front edge of said envelope being very sharp or, on demand, provided with a flange Br for allowing connection to installations, the four zones comprising:

a first zone for (1) for injecting the fluid, which is an empty space or a space containing valves or inducers, of the corkscrew type, which optionally cause a pre-rotation of the fluid which enters a second zone (2), a pointed shield pushing the flow of fluid away from the centre on arrival, and directing it away towards the second zone (2), the second zone (2) where the rotation of the fluid is created in channels that wind in spirals and open up at the rear of the second zone (2), rotating the fluid, a third zone (3) containing the rotating wheel provided with buckets with calibrated jets that harness the energy supplied by the jets of fluid leaving the second zone (2), and a fourth zone (4) containing a housing attached to the stationary casing of the turbine and placed after the rotating wheel, said housing containing channels that orient the fluid towards the outlet at the rear of the turbine, and the fluid is guided, as soon as it reaches the second zone (2), by channels contained in tubes that are arranged in continuity face to face, over the entire length of the turbine.

### TECHNICAL FIELD

The present invention relates to a method for designing and fabricating on demand turbines having buckets with calibrated jets.

### PRIOR ART

Turbines used to generate energy supplied by a fluid are essentially built on the basis of the kinetic energy supplied by the impact of fluids on the surface of propeller blades of all sizes.

They can be of large dimensions such as those of windmills, fans, or those of fans for aircraft engines, or helicopters, or smaller and stacked like those of turbomolecular vacuum pumps, or helicopter turbines or aircraft engines, where many stages of small blades are added. Centrifugal force is also used by means of open or closed centrifugal wheels such as those of helicopter turbines. Much larger forces can also be generated by reaction, such as those of rockets. The

PELTON turbine is an exception in that it uses a jet of fluid which successively strikes buckets positioned at the periphery around a wheel which they rotate by reaction on the ambient fluid. TURGO turbines also use buckets struck laterally to the wheel.

For example, propellers have been used for a very long time to capture energy from fluids, for example wind turbines with reasonable dimensions are used in desert countries to extract water from wells and in Europe to provide drinking water for cows in fields or even in windmills to make flour.

If the latter have survived the test of time, it is because they have a large air exchange surface, called wetted surface, owing to the many wide blades that cover almost the entire circle, thus capturing the maximum amount of energy contained in the wind with a minimum diameter. The new very large wind turbines that are ruining our landscapes do not have a significant wetted surface and moreover have average yields of around 20%.

The main difficulties encountered in previous decades were that the fabrication of complex shapes was very difficult even with the latest high-performance chip-removal machines. Pierre CARROUSET's 1990 patent for an 8-axis numerical control machine had already been using the computer with BEZIER curves since 1985. They worked on the cutting point of the tangent of the cylindrical milling cutter, located at the central point of the machine, around which the workpiece was moved.

Digital technology, computers, mathematical parameterisation software, 3D additive machines, enabled CARPYZ with the BEZIER curves from 1996 to start producing, in an artisanal individual manner, very complicated single-component pump turbines that could not be built before, by first creating them on screen with BEZIER curves and then having them fabricated using stereo lithography.

Stubbornly continuing their research and thanks to the discovery in 2006 of a CARPYZ arithmetic principle known as the five-parameter arithmetic principle (publication WO2008/012425, patent application PCT/FR2007/0011267), CARPYZ SAS Ingénierie, created in 2017, has continued its research for more than 10 years.

The publication WO2008/012425 (PCT/2007/011267) describes in detail the so-called five-parameter arithmetic principle, known to a person skilled in the art who keeps up with global technical innovations, who is therefore immediately informed by this publication WO2008/012425, if not already fully informed of this principle.

The so-called five-parameter arithmetic principle makes it possible to fabricate a double-sided blade by simultaneously using only a choice of five numerical values, namely numerical values for 1) the leading edge, 2) the trailing edge, 3) the body, 4) the length, and 5) the camber, respectively.

This made it possible to discover and fabricate, instinctively at first, some samples based on the principle of the PELTON turbine. For example, patent publications FR 2 997 460 of 29 Oct. 2012 and WO2014067823 (A1) describe that turbines first orient the fluid tangentially, through channels around a stationary hollow wheel, and the jets are received in a rotating wheel which surrounds the stationary wheel, in buckets according to the principle of the wheels of Pelton turbines. This method makes it possible to build turbine assemblies capable of recovering energy from moving fluids such as wind turbines or tidal turbines with a minimum capture surface and maximum efficiency.

In particular, the publication WO2014067823 (A1) describes a known method of this type using the CARPYZ arithmetic principle referred to as the 5-parameter arithmetic principle, applied to a turbine comprising at least two 3D hollow wheels nested one inside the other in which, on the one hand, a stationary hollow wheel is open at the front at the inlet of the fluid at its largest diameter and is made up of successive curved circular washers which each have an internal diameter that decreases from the front to the centre and have an inner edge oriented towards the front and are intersected by blades that are preferably wound in a spiral which run from the front to the centre and form with the washers channels oriented tangentially towards the periphery of the wheel and, on the other hand, at least one rotating wheel which surrounds the stationary wheel consists of blades preferably wound in a spiral which run from the large diameter towards the centre and are curved in the form of hollow buckets, one of the spouts of which is oriented tangentially to the inside of this wheel and these bucket blades are intersected by circular washers which go from the inside to the outside and partition the buckets and the inner edges of said washers are at best in continuity with the washers of the stationary wheel.

The so-called five-parameter industrial computer tool makes it possible to easily generate, on demand and infinitely, helical blades of very complex shapes and provides the computer files for building same. A person skilled in the art must provide all the numerical values necessary for the so-called “five-parameter” principle for each element described independently. A person skilled in the art is able to associate the elements with one another as described.

This so-called “five-parameter” principle is a rare industrial IT tool that discloses a calculation principle without numerical references.

### SUMMARY OF THE INVENTION

With a view to improving axial thrust, it is therefore clear that there is a need for a method for designing and fabricating on demand turbines having buckets with calibrated jets which, to a large extent, overcomes the shortcomings that have been encountered in the prior art. One aim of the invention is to provide a method which makes it possible to design, build and fabricate turbines with CARPYZ calibrated jet bucket wheels, all of the elements of which are fully digitised, and which are suitable for any fluids, any uses, and any sizes, on demand.

To this end, the method for designing and fabricating on demand turbines having buckets with calibrated jets according to the invention is characterised in that the skeletons of the turbines displayed on the screen allow them to be designed and then fabricated in any dimensions, any materials and any quantities, and they are built with blades designed according to the so-called five-parameter arithmetic principle. The skeleton of the turbine is displayed on the screen by means of “virtual neutral fibres” which are subsequently covered with a material, the turbines being contained, over the entire length thereof, in a circular envelope, which is in principle slightly rounded and has a diameter that varies over the length thereof according to the contents of the envelope. The length of said single-component envelope is shown on a drawing and divided into four zones intersected by temporary virtual discs which each separate the zones according to the functions carried out in such areas, the front edge of said envelope being very sharp or, on demand, provided with a flange Br for allowing connection to installations. These four zones comprise:

a first zone for (1) for injecting the fluid, which is an empty space or a space containing valves or inducers, of the corkscrew type, which optionally cause a pre-rotation of the fluid which enters a second zone (2), a pointed shield pushing the flow of fluid away from the centre on arrival, and directing it away towards the second zone (2),

the second zone (2) where the rotation of the fluid is created in channels that wind in spirals and open up at the rear of the second zone (2), rotating the fluid,

a third zone (3) containing the rotating wheel provided with buckets with calibrated jets that harness the energy supplied by the jets of fluid leaving the second zone (2), and

a fourth zone (4) containing a housing attached to the stationary casing of the turbine and placed after the rotating wheel, said housing containing channels that orient the fluid towards the outlet at the rear of the turbine, and

the fluid is guided, as soon as it reaches the second zone (2), by channels contained in tubes that are arranged in continuity face to face, over the entire length of the turbine.

The so-called five-parameter arithmetic principle therefore makes it possible to fabricate a double-sided blade by simultaneously using only a choice of five numerical values, namely numerical values for 1) the leading edge, 2) the trailing edge, 3) the body, 4) the length, and 5) the camber, respectively.

The CARPYZ industrial computer tool makes it possible to easily generate, on demand and infinitely, helical blades of very complex shapes and provides the computer files for building same.

By following step-by-step what is described in the application, a person skilled in the art can concretely produce on the screen the turbines of their choice, as the applicant does, and provide files which allow them to be built physically by additive manufacturing all over the world.

A person skilled in the art must provide all the numerical values necessary for the so-called “five-parameter” principle for each element described independently in the patent application.

A person skilled in the art is able to associate the elements with one another as described in the application.

This novel invention does away with this method by employing everywhere the aforementioned five-parameter principle which allows in a novel way a more methodical construction of all the constituent elements of the turbines having buckets with calibrated jets according to the invention.

According to the invention, “the so-called five-parameter arithmetic principle” is used. This feature refers to the industrial computer tool for computer-aided design and manufacturing, which was developed by the applicant of the present application. However, this precise principle is universally accepted and defines a standard principle or procedure that is accepted internationally as a particular sequence of standard operations.

The interest of the method for designing and fabricating on demand turbines having buckets with calibrated jets according to the invention is to be able to design and fabricate turbines, uses the “so-called 5-parameter principle” which allows the creation of hollow curved lines that can be bulged as desired on the basis of only five numerical values, which are:
a value for the diameter of a circle for the leading edge of the blade,
a value for the diameter of a circle for the trailing edge of the blade,
a value for the diameter of a circle placed at the centre of the blade for its body,
a value for the camber obtained by the relative position of the three aforementioned circles to one another,
and a value for the length of the blade.

This novel invention shows how CARPYZ turbines with buckets are built using known geometric and mathematical principles and laws, but which are associated and used simultaneously or independently in complementary ways. Each principle, while perhaps already known individually elsewhere, cannot be regarded as sufficient opposition having been taken out of the overall context, since the elements of the single-component wheel are all dependent on one another.

It was discovered that by using its so-called CARPYZ 5-parameter arithmetic principle, it is possible to design, build and fabricate turbines having bucket wheels with calibrated jets, all of the elements of which are fully digitised, and which are adapted on demand to any fluids, for any uses and any sizes. The device is remarkable in that the skeletons of the turbines displayed on the screen allow them to be designed and then fabricated in any dimensions, any materials and any quantities, and they are built with blades designed according to the CARPYZ 5-parameter arithmetic principle (see publication WO2008/012425, PCT/FR2007/0011267).

A person skilled in the art therefore has all the information available by the reference to the “five-parameter” arithmetic principle, which is not a generally known descriptive term. This known “five-parameter” arithmetic principle enables a person skilled in the art to know exactly how the design and fabrication of the turbine with its first, second, third and fourth zones should be effectively carried out for the design and fabrication on demand of turbines having buckets with calibrated jets according to the invention as set out in the claims. By taking into account the present description and their general technical knowledge, including specific knowledge of this industrial computer tool, a person skilled in the art can easily reproduce the invention, i.e. fabricate the claimed turbines, with the instructions and information that can be derived therefrom.

Preferably, unless they are provided with flanges, the edges of the tubes at the inlet of the second zone (2) and at the outlet of the tubes of the fourth zone (4) are very sharp, and the edges of the buckets of the third zone (3) are very sharp, the edges of the tubes of the bucket wheel and those of the tubes which surround it having the same diameter, being flat and rotating opposite one another.

In a preferred embodiment of the invention, the channels are built from stationary circular tubes of different diameters, which are contained one inside the other, and which start from the front of the second zone (2) with sharp edges (3, FIG. 4) and the diameters of which are scalable, these tubes being continued face to face in line with identical tubes contained in a rotary housing which contains the buckets, these rotary tubes being again continued face to face in line with the stationary tubes contained in the housing attached to the stationary casing of the turbine in the fourth zone (4).

In a preferred embodiment of the invention, starting from the front face of the second zone (2), straight or inclined radial blades with sharp edges wind in the direction chosen by the designer, spiralling backwards in the tubes, forming channels which rotate the fluid, and project it out at the outlet by their sharp edges, into the buckets, straight or inclined radial blades the edges of which are sharp also being contained between the tubes of the stationary housing of the fourth zone (4).

In a preferred embodiment of the invention, the wheel of the third zone (3) which rotates, is built with buckets which are placed in the wheel between its tubes, the buckets being open-mouthed portions of circles, oriented for their feeding according to the direction of rotation decided by the designer, the buckets being modifiable by changing the values of the width of the wheel, their inclination and their depth, the results obtained changing with the diameter of the wheel and with the number of buckets which are determined by the designer.

Preferably, a virtual straight line is drawn between the two edges of the bucket and a centre is pointed at the middle of this line, and in that, relative to this centre are placed with a differential at [symbol] , [symbol] , α, as desired by the designer, the centres of portions of a circle which position the opposing bumps that choke the interior jet of the bucket.

In a preferred embodiment of the invention, starting from the edges of the bump, curved lines are drawn by the designer which tangentially touch the back of each bucket that precedes them.

Preferably, a hole is drilled at the centre of the bumps over the entire height of the chamber.

In a preferred embodiment of the invention, the rotary chamber of the bucket wheel is mechanically connected to the turbine shaft. Inside the second zone (2) an electric generator is placed on the shaft, the stator of which is attached to the interior of all the channels for rotating the fluid, the rotor of this electric generator being attached to the turbine shaft and being mechanically connected to the stator by a plain or ball bearing or thrust bearing, the other end of the shaft exiting on the other side after the wheel and allowing the mechanical energy produced to be used with pulleys or electrical generators held by supports connected to the turbine envelope.

Preferably, electricity production is carried out by devices based on the principle of brushless motors, by attaching magnets all around at the periphery of the rotating bucket wheel, and by attaching the coils, which receive the magnetic fields of the magnets, which are placed in line with the periphery on the envelope of the turbine using magnetic and non-magnetic elements with low remanence.

### BRIEF DESCRIPTION OF THE FIGURES

The figures are provided for information and are schematic and simplified to best illustrate the texts of the description and the claims.

FIG. 1 shows as an example the buckets which can be modified by changing the values of the width of the wheel, their inclination and their depth;

FIG. 2 shows, starting from the edges of the bump, curved lines drawn by the designer which touch at their tangent the back of each bucket that precedes them;

FIG. 3 shows in section a half-turbine cut along the axis of the shaft, divided into four zones;

FIG. 4 shows the so-called 5-parameter principle applied to the buckets;

FIG. 5 shows the generation of the bumps on demand by moving the position of the centres with [symbol] , [symbol] , α, in order to be able to modify the channel of the bucket which conditions the jet of the fluid as desired.

### DETAILED DESCRIPTION OF THE INVENTION

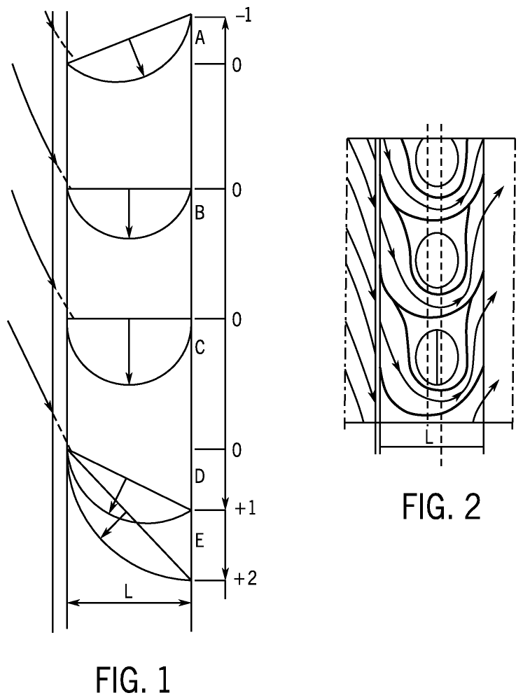

FIGS. 1 to 5 are provided to show schematically by way of example the principle of construction of the turbines having buckets with calibrated jets, but do not limit it the presented drawings in any way. FIG. 4 shows the CARPYZ 5-parameter arithmetic principle and shows that the edges (3) of a bucket can be very sharp as the diameters used with the computer and obtained with the 3D additive machines can be extremely thin and practically invisible and sharp. This same drawing also shows that the edge of the end of the tubes can be flat.

FIG. 1 shows that it is possible to modify the depth of the hollow of the bucket and its angle as desired.

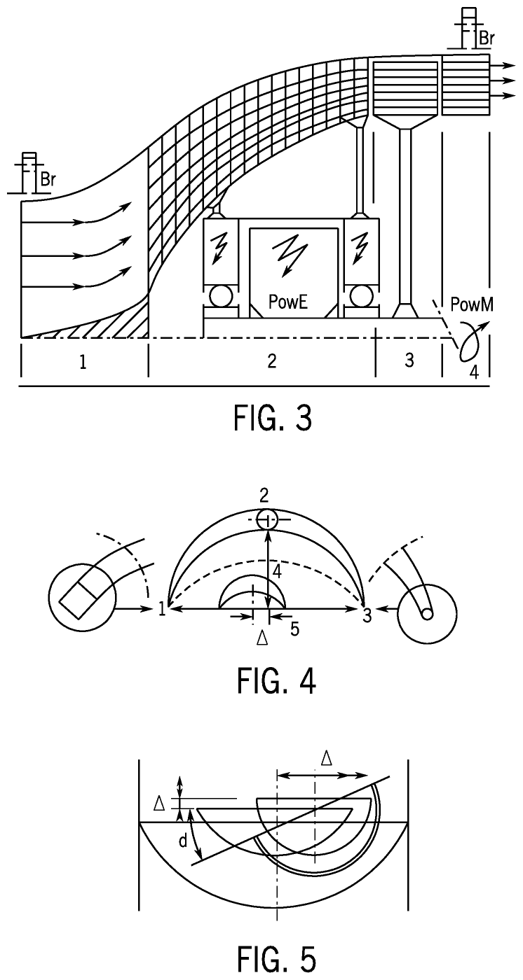

FIG. 5 shows that by moving the position of the centres with [symbol] , [symbol] , α, bumps are generated on demand and the channel of the bucket which conditions the jet of the fluid can be modified as desired. FIG. 3 shows in section a half-turbine cut along the axis of the shaft. The fluid inlet is arrowed to the left of the drawing and the circular envelope in bold, the edge of which can be sharp in the case of ambient fluid intake, or provided with a flange (Br) for its connection to an installation. It shows the channels made up of concentric tubes and the radial blades. It also shows the rotating chamber, the circular tubes of which contain the buckets, which correspond to the tubes of the channels that feed in the fluid. It also shows that after the rotating chamber, a housing is attached to the turbine casing, which is built with tubes which are in continuity face to face with those of the bucket wheel and which also contain profiled radial spacers that orient the fluid towards the arrowed outlet. The rotating chamber is secured to the shaft which turns the rotor of an electricity generator contained inside the turbine (PowE). The external outlet on the right can allow the mechanical energy to be used (PowM).

FIG. 1 shows that by using the 5 parameters it is possible to orient the buckets and change their dimensions.

FIG. 5 shows that a bump is placed inside the bucket and that the centre of this bump is shifted on demand from the centre of the axis drawn between the edges of the bucket and allows the modification of the size of the channel between the bump and the bottom of the bucket. FIG. 2 shows the portions of curves that connect the front edge of the bump to the tangent of the bucket which precedes it. It also shows an oblong central hole that passes through the chamber.

FIG. 4 shows the so-called 5-parameter principle.

As can be seen in FIG. 3, the skeleton of the turbine is displayed on the screen using “'virtual neutral fibres” which are subsequently covered with a material. The turbines are contained, over the entire length thereof, in a circular envelope, which is in principle slightly rounded and has a diameter that varies over the length thereof according to the contents of the envelope. The length of said single-component envelope is shown on the drawing and divided into four zones intersected by temporary virtual discs which each separate the zones according to the functions carried out in such areas.

The front edge of said envelope is very sharp or, on demand, provided with a flange Br for allowing connection to installations.

These four zones comprise:

a ZONE 1 for injecting the fluid, which is an empty space or a space containing valves or inducers, of the corkscrew type, which optionally cause a pre-rotation of the fluid which enters zone 2. FIG. 3. A pointed shield pushes the flow of fluid away from the centre on arrival, and directs it away towards zone 2.

a ZONE 2 where the rotation of the fluid is created in channels that wind in spirals and open up at the rear of zone 2 rotating the fluid,

a ZONE 3 containing the rotating wheel provided with buckets with calibrated jets that harness the energy supplied by the jets of fluid leaving zone 2, and

a ZONE 4 containing a housing attached to the stationary casing of the turbine and placed after the rotating wheel, which contains channels that orient the fluid towards the outlet at the rear of the turbine. The fluid is guided, as soon as it reaches zone 2, by channels contained in tubes that are arranged in continuity face to face, over the entire length of the turbine. Unless they are provided with flanges, the edges of the tubes at the inlet to zone 2 and at the outlet of the tubes from zone 4 are very sharp. The edges of the buckets in zone 3 are very sharp.

The edges of the tubes of the bucket wheel and those of the tubes which surround it have the same diameter, are flat (FIG. 4) and turn opposite one another. The channels are built from stationary circular tubes of different diameters, which are contained within each other, and which start from the front of zone 2 with sharp edges (3 of FIG. 4) and the diameters of which are scalable. These tubes are continued face to face in line with identical tubes contained in a rotating chamber which contains the buckets. These rotating tubes are again continued face to face in line with the stationary tubes contained in the housing connected to the stationary casing of the turbine (zone 4).

FIG. 3 shows, starting from the front face of zone 2, straight or inclined radial blades of which the sharp edges wind in the direction chosen by the designer, spiralling backwards in the tubes, forming channels which rotate the fluid, and project it out at the outlet by their sharp edges, into the buckets.

Straight or inclined radial blades, the edges of which are sharp, are also contained between the tubes of the stationary housing of zone 4. The wheel of zone 3 which rotates, is built with buckets which are placed in the wheel between its tubes. The buckets are portions of open-mouthed circles, oriented for their feeding according to the direction of rotation decided by the designer.

As can be seen in FIG. 1, the buckets are modified by changing the values of the width of the wheel, their inclination and their depth. The results obtained change with the diameter of the wheel and with the number of buckets which are determined by the designer. A virtual straight line is drawn between the two edges of the bucket and a centre is pointed at the middle of this line.

As can be seen in FIG. 5, relative to this centre are placed with a differential at [symbol] , [symbol] , α, as desired by the designer, the centres of portions of a circle which position the opposing bumps that choke the interior jet of the bucket.

FIG. 2 shows that, starting from the edges of the bump, curved lines are drawn by the designer that tangentially touch the back of each bucket that precedes them.

At the centre of the bumps a hole is drilled over the entire height of the chamber. The rotary chamber of the bucket wheel is mechanically connected to the turbine shaft (FIG. 3).

Inside zone 2 on the shaft is placed an electric generator, the stator of which is attached to the interior of all the channels for rotating the fluid. The rotor of this electric generator is attached to the shaft of the turbine and is mechanically connected to the stator by a plain or ball bearing or thrust bearing. The other end of the shaft comes out on the other side after the wheel and makes it possible to use the mechanical energy produced with pulleys or electric generators held by supports connected to the envelope of the turbine (FIG. 3).

Electricity production is carried out by devices based on the principle of brushless motors, by attaching magnets all around at the periphery of the rotating bucket wheel, and by attaching the coils, which receive the magnetic fields of the magnets, which are placed in line with the periphery on the envelope of the turbine using magnetic and non-magnetic elements with low remanence.

The present invention is not in any way limited to the embodiment described by way of example and shown in the drawings. Numerous modifications of the details, shapes and dimensions could be made without departing from the scope of the invention. The present invention has been described with reference to specific embodiments which are purely illustrative and should not be considered limiting. The reference numbers in the claims do not limit the scope thereof.

1. A method for designing and fabricating on demand turbines having buckets with calibrated jets, the skeletons of the turbines displayed on the screen allowing them to be designed and then fabricated in any dimensions, any materials and any quantities, and they are built with blades designed according to the so-called five-parameter arithmetic principle, allowing the creation of hollow curved lines that can be bulged as desired starting from only five numerical values, which are:
a value for the diameter of a circle for the leading edge of the blade,
a value for the diameter of a circle for the trailing edge of the blade,
a value for the diameter of a circle placed at the centre of the blade for its body,
a value for the camber obtained by the relative position of the three aforementioned circles to one another,
and a value for the length of the blade,
the skeleton of the turbine being displayed on the screen by means of “virtual neutral fibres” which are subsequently covered with a material, the turbines being contained, over the entire length thereof, in a circular envelope, which is in principle slightly rounded and has a diameter that varies over the length thereof according to the contents of the envelope,
the length of said single-component envelope being shown on a drawing and divided into four zones intersected by temporary virtual discs which each separate the zones according to the functions carried out in such areas, the front edge of said envelope being very sharp or, on demand, provided with a flange Br for allowing connection to installations,
the four zones comprising:
a first zone for (1) for injecting the fluid, which is an empty space or a space containing valves or inducers, of the corkscrew type, which optionally cause a pre-rotation of the fluid which enters a second zone (2), a pointed shield pushing the flow of fluid away from the centre on arrival, and directing it away towards the second zone (2),
the second zone (2) where the rotation of the fluid is created in channels that wind in spirals and open up at the rear of the second zone (2), rotating the fluid,
characterised in that a third zone (3) containing the rotating wheel is provided with buckets with calibrated jets that harness the energy supplied by the jets of fluid leaving the second zone (2), and
a fourth zone (4) containing a housing attached to the stationary casing of the turbine and placed after the rotating wheel, which contains channels that orient the fluid towards the outlet at the rear of the turbine,
the fluid being guided, as soon as it reaches the second zone (2), by channels contained in tubes that are arranged in continuity face to face, over the entire length of the turbine, and in that
the wheel of the third zone (3) which rotates, is built with the buckets which are placed in the wheel between its tubes, the buckets being open-mouthed portions of circles, oriented for their feeding according to the direction of rotation decided by the designer, the buckets being modifiable by changing the values of the width of the wheel, their inclination and their depth, the results obtained changing with the diameter of the wheel and with the number of buckets which are determined by the designer.

2. The method for designing and fabricating on demand turbines having buckets with calibrated jets, which are built according to claim 1, wherein, unless they are provided with flanges, the edges of the tubes at the inlet of the second zone (2) and at the outlet of the tubes of the fourth zone (4) are very sharp, and in that the edges of the buckets of the third zone (3) are very sharp, the edges of the tubes of the bucket wheel and those of the tubes which surround it having the same diameter, being flat and rotating opposite one another.

3. The method for designing and fabricating on demand turbines having buckets with calibrated jets, which are built according to claim 1, wherein the channels are built from stationary circular tubes of different diameters, which are contained one inside the other, and which start from the front of the second zone (2) with sharp edges (3, FIG. 4) and the diameters of which are scalable, these tubes being continued face to face in line with identical tubes contained in a rotary housing which contains the buckets, these rotary tubes being again continued face to face in line with the stationary tubes contained in the housing attached to the stationary casing of the turbine in the fourth zone (4).

4. The method for designing and fabricating on demand turbines having buckets with calibrated jets according to claim 1, wherein, starting from the front face of the second zone (2), straight or inclined radial blades with sharp edges wind in the direction chosen by the designer, spiralling backwards in the tubes, forming channels which rotate the fluid, and project it out at the outlet by their sharp edges, into the buckets, straight or inclined radial blades the edges of which are sharp also being contained between the tubes of the stationary housing of the fourth zone (4).

5. The method for designing and fabricating on demand turbines having buckets with calibrated jets according to claim 4, wherein a virtual straight line is drawn between the two edges of the bucket and that a centre is pointed at the middle of this line, and in that, relative to this centre are placed with a differential at [symbol] , [symbol] , α, as desired by the designer, the centres of portions of a circle which position the opposing bumps that choke the interior jet of the bucket.

6. The method for designing and fabricating on demand turbines having buckets with calibrated jets, which are built according to claim 5, wherein, starting from the edges of the bump, curved lines are drawn by the designer which tangentially touch the back of each bucket that precedes them.

7. The method for designing and fabricating on demand turbines having buckets with calibrated jets, which are built according to claim 6, wherein at the centre of the bumps a hole is drilled over the entire height of the chamber.

8. The method for designing and fabricating on demand turbines having buckets with calibrated jets, according to claim 7, wherein the rotary chamber of the bucket wheel is mechanically connected to the turbine shaft inside the second zone (2) an electric generator is placed on the shaft, the stator of which is attached to the interior of all the channels for rotating the fluid, the rotor of this electric generator being fixed to the turbine shaft and being mechanically connected to the stator by a plain or ball bearing or thrust bearing, the other end of the shaft exiting on the other side after the wheel and allowing the mechanical energy produced to be used with pulleys or electrical generators held by supports connected to the turbine envelope.

9. The method for designing and fabricating on demand turbines having buckets with calibrated jets according to claim 1, wherein the electricity production is carried out by devices based on the principle of brushless motors, by attaching magnets all around at the periphery of the rotating bucket wheel, and by attaching the coils, which receive the magnetic fields of the magnets, which are placed in line with the periphery on the envelope of the turbine using magnetic and non-magnetic elements with low remanence.

10. The method for designing and fabricating on demand turbines having buckets with calibrated jets, which are built according claim 2, characterised in that the channels are built from stationary circular tubes of different diameters, which are contained one inside the other, and which start from the front of the second zone (2) with sharp edges (3, FIG. 4) and the diameters of which are scalable, these tubes being continued face to face in line with identical tubes contained in a rotary housing which contains the buckets, these rotary tubes being again continued face to face in line with the stationary tubes contained in the housing attached to the stationary casing of the turbine in the fourth zone (4).

11. The method for designing and fabricating on demand turbines having buckets with calibrated jets according to claim 2, characterised in that, starting from the front face of the second zone (2), straight or inclined radial blades with sharp edges wind in the direction chosen by the designer, spiralling backwards in the tubes, forming channels which rotate the fluid, and project it out at the outlet by their sharp edges, into the buckets, straight or inclined radial blades the edges of which are sharp also being contained between the tubes of the stationary housing of the fourth zone (4).

12. The method for designing and fabricating on demand turbines having buckets with calibrated jets according to claim 3, characterised in that, starting from the front face of the second zone (2), straight or inclined radial blades with sharp edges wind in the direction chosen by the designer, spiralling backwards in the tubes, forming channels which rotate the fluid, and project it out at the outlet by their sharp edges, into the buckets, straight or inclined radial blades the edges of which are sharp also being contained between the tubes of the stationary housing of the fourth zone (4).

13. The method for designing and fabricating on demand turbines having buckets with calibrated jets according to claim 10, characterised in that, starting from the front face of the second zone (2), straight or inclined radial blades with sharp edges wind in the direction chosen by the designer, spiralling backwards in the tubes, forming channels which rotate the fluid, and project it out at the outlet by their sharp edges, into the buckets, straight or inclined radial blades the edges of which are sharp also being contained between the tubes of the stationary housing of the fourth zone (4).
